(19) United States
(12) Patent Application Publication
(10) Pub. No.: US 2002/0151217 A1
(43) Pub. Date: Oct. 17, 2002

(54) Electrically shielded connector with over-molded insulating cover

(76) Inventors: James W. Ivey JR., Wendell, NC (US); Keith Bass, Redding, CA (US)

Correspondence Address: ALCATEL USA, INTELLECTUAL PROPERTY DEPARTMENT, 1000 COIT ROAD, MS LEGL2, PLANO, TX, 75075, US

(21) Appl. No.: 10/164,135

(22) Filed: Jun. 4, 2002

Related U.S. Application Data
(63) Continuation of application No. 09/812,080, filed on Mar. 19, 2001, now Pat. No. 6,409,542.

(51) Int. Cl. H01R 13/648

(52) U.S. Cl. 439/607

(57) ABSTRACT

One embodiment of a shielded cable assembly as disclosed herein includes a connector body including a wire attachment region. A contact member, including a wire attachment portion, is mounted on the connector body with the wire attachment portion positioned adjacent to the wire attachment region of the connector body. An insulating insert, including a wire-receiving region, is positioned adjacent to the connector body with at least a portion of the wire attachment region of the connector body extending into the wire-receiving region. A wire of a cable extends into the wire-receiving region of the insulating insert and is electrically connected to the wire attachment portion of the contact member. A shielding body, including an insert-receiving region, has at least a portion of the insulating insert positioned in the insert-receiving region. An insulating cover covers at least a portion of the shielding body.

### CLAIM OF PRIORITY

The present application is a continuation application and claims priority to the U.S. patent application filed Mar. 19, 2001, Ser. No. 09/812,080, entitled “Electrically Shielded Connector with Over-Molded Insulating Cover”, inventors James W. Ivey, Jr., and Keith Bass.

### FIELD OF THE DISCLOSURE

The disclosures herein relate generally to electrical connectors and more particularly to electrically shielded connectors with over-molded insulating covers.

### BACKGROUND

High speed electronic equipment, such as high-speed computer equipment and telecommunications equipment, often require the use of cable assemblies including shielded cables, shielded connectors or both. The space requirements for such equipment sometimes limit the physical size for the connectors or such cable assemblies. In these situations, a low profile shielded connector is often required.

An over-molding process is often used for forming the insulating cover of a low-profile shielded connector. The shielded connector included a shielding body that can be inadvertently deformed during the over-molding process. Because the shielding body is conductive, deformation of the shielding body sometimes results in a short circuit between the shielding body and one or more of the electrical connections between the connector and the cable. Deformation of the shielding body also result in a conductor of the cable being unintentionally disconnected from a corresponding electrical contact of the connector. When such a short circuit or discontinuity exists, the cable assembly is defective, thus requiring it to be repaired or scrapped.

One conventional solution to limit deformation of the shielding body is to use a more robust shielding body in over-molded connector applications. The use of a more robust shielding body typically results in the shielding body being larger due to an increased wall thickness of the shielding body, due to structural features added to increase the strength of the shielding body or both. Increasing the size of the shielding body often precludes the corresponding connector from being used in applications in which a low-profile shielded connector is required.

Accordingly, a shielded connector with an over-molded insulating cover that is made in a manner that reduces the potential for shorting of the shielding body and or damaging the electrical connections in the shielding body without increasing the size of the connector is useful.

### SUMMARY

One embodiment of a shielded cable assembly as disclosed herein includes a connector body including a wire attachment region. A contact member, including a wire attachment portion, is mounted on the connector body with the wire attachment portion positioned adjacent to the wire attachment region of the connector body. An insulating insert, including a wire-receiving region, is positioned adjacent to the connector body with at least a portion of the wire attachment region of the connector body extending into the wire-receiving region. A wire of a cable extends into the wire-receiving region of the insulating insert and is electrically connected to the wire attachment portion of the contact member. A shielding body, including an insert-receiving region, has at least a portion of the insulating insert positioned in the insert-receiving region. An insulating cover covers at least a portion of the shielding body.

### BRIEF DESCRIPTION OF THE DRAWINGS

FIG. 1 is a perspective view depicting an embodiment of a shielded cable assembly.

FIG. 2 is a cross sectional view taken along the line 2-2 in FIG. 1.

FIG. 3 is an exploded perspective view depicting an embodiment of a multi-piece insulating insert.

FIG. 4 is a perspective view depicting an embodiment of a one-piece insulating insert.

FIG. 5 is an exploded perspective view depicting an embodiment of a multi-piece shielding body.

FIG. 6 is a perspective view depicting the shielding body depicted in FIG. 5 in an assembled configuration.

FIG. 7 is an exploded perspective view depicting an embodiment of an insulating insert having shut-off surfaces.

FIG. 8 is an end view depicting the insulating insert of FIG. 7 attached to a connector body.

FIG. 9 is a flow chart view depicting an embodiment of a method for fabricating a shielded cable assembly as disclosed herein.

### DETAILED DESCRIPTION

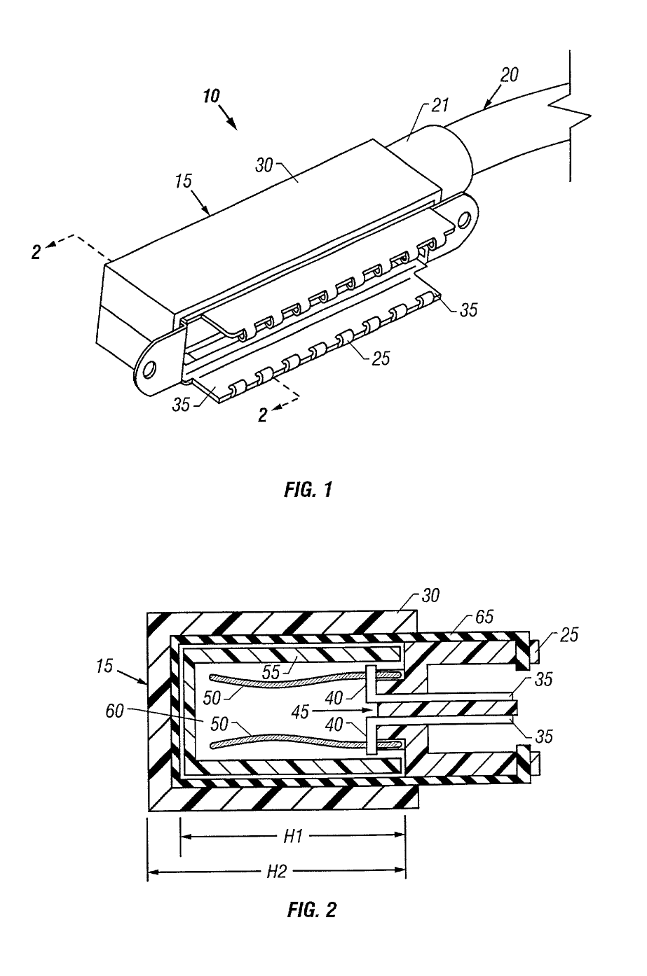

An embodiment of a shielded cable assembly 10 is depicted in FIG. 1. The shielded cable assembly 10 includes a shielded connector assembly 15 electrically connected to a first end 21 of a shielded cable 20. The shielded cable assembly 10 may have another connector assembly, such as another shielded connector assembly 15, electrically connected at a second end thereof. The shielded connector assembly 15 includes a connector body 25 having an insulating cover 30 formed thereon. An over-molding operation is one example of a suitable technique for forming the insulating cover 30 on the connector body 25. The connector body 25 includes a plurality of contacts members 35 attached thereto. A connector assembly comprises the connector body 25 and the plurality of contact members 35.

As depicted in FIG. 2, each one of the contact members 35 includes a wire attachment portion 40 adjacent to a wire attachment region 45 of the connector body 25. The wire attachment portion 40 of at least one of the contact members 35 has an insulated wire 50 attached thereto. An insulation displacement element is an example of the wire attachment portion 40.

The shielded connector assembly 15 includes an insulating insert 55. The wire attachment portion 40 of each one of the contact members 35 and the adjacent portion of each attached insulated wire 50 are positioned in a wire-receiving region 60 of the insulating insert 55. A cavity defined by the insulating insert is an example of the wire-receiving region 55. The insulating insert 55 is made from a non-conductive material such as a polymeric material. Nylon, polyethylene, polypropylene, and polyester are examples of suitable polymeric materials. The insulating insert 55 may be formed using a technique such as injection molding, extrusion, or any other suitable manufacturing technique.

Still referring to FIG. 2, the shielded connector assembly 15 includes a shielding body 65 for limiting adverse affects of electromagnetic interference (EMI). The shielding body 65 covers at least a portion of the connector body 25 and at least a portion of the insulating insert 55. It is advantageous for the shielding body 65 to cover a significant portion of the connector body 25 and the insulating insert 55. In this manner, the potential for adverse affects associated with EMI is reduced.

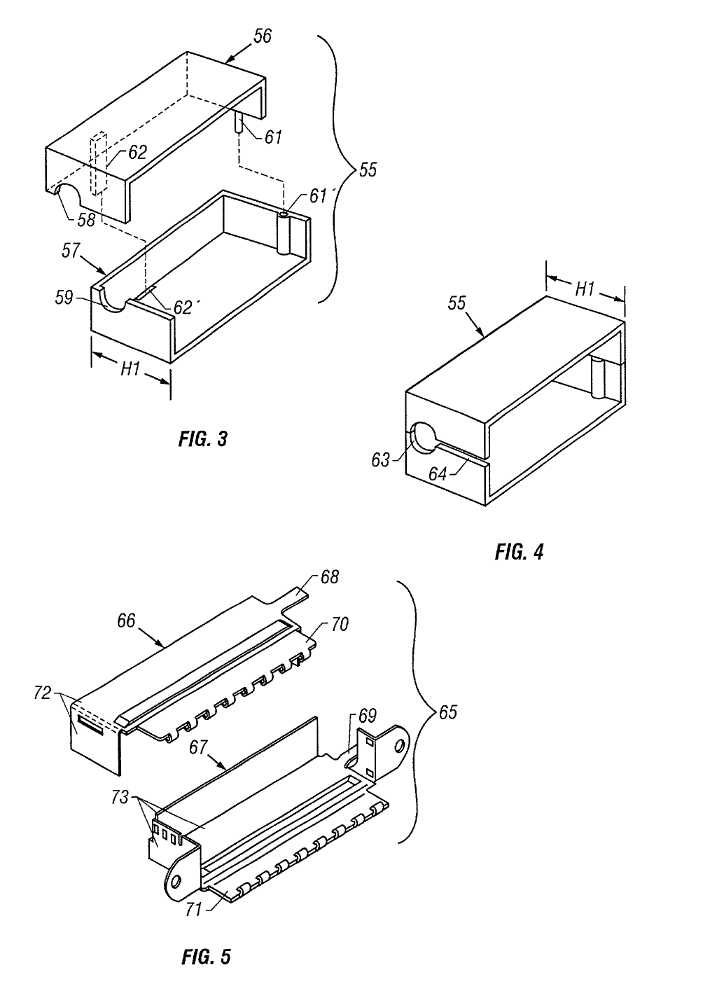

A multi-piece embodiment of the insulating insert 55 is depicted in FIG. 3. The multi piece embodiment of the insulating insert 55 includes a first insert member 56 and a second insert member 57. The first and the second insert members 56, 57 include respective wire-receiving port surfaces 58, 59. The first and the second insulating members 66, 67 are capable of being assembled over the wire attachment region 45 of the connector body 25. In this manner, the first and the second insulating members 66, 67 jointly define the wire-receiving region 60, FIG. 1, for receiving the wire attachment region 45 of the connector body 25 and the adjacent portion of the wire 50 attached to each one of the contact members 35. Furthermore, when the first and the second insulating members 66, 67 are assembled, one or more wires 50 of the cable 20, FIG. 1, passes through a wire-receiving port jointly defined by the wire-receiving port surfaces 58, 59.

The first insulating member 56 includes a first alignment member 61 that is received by a first mating alignment feature 61′ of the second insulating member 56. The first insulating member 56 includes a second alignment member 62 that is received by a second mating alignment feature 62′ of the second insulating member 56. The alignment members 61, 62 and the respective mating alignment features 61′, 62′ aid in maintaining alignment of the first insulating member 56 with the second alignment member 57.

A one-piece embodiment of the insulating insert 55 is depicted in FIG. 4. The one piece embodiment of the insulating embodiment 55, as depicted in FIG. 4 has a wire-receiving port 63 and a wire insertion slot 64 for enabling one or more wires 50 of the cable 20, FIG. 1, to be positioned in the wire-receiving port 63. It is contemplated that the one-piece embodiment of the insulating insert 55 may be substantially the two-piece embodiment of the insulating member 55, depicted in FIG. 3, having a clamshell type construction.

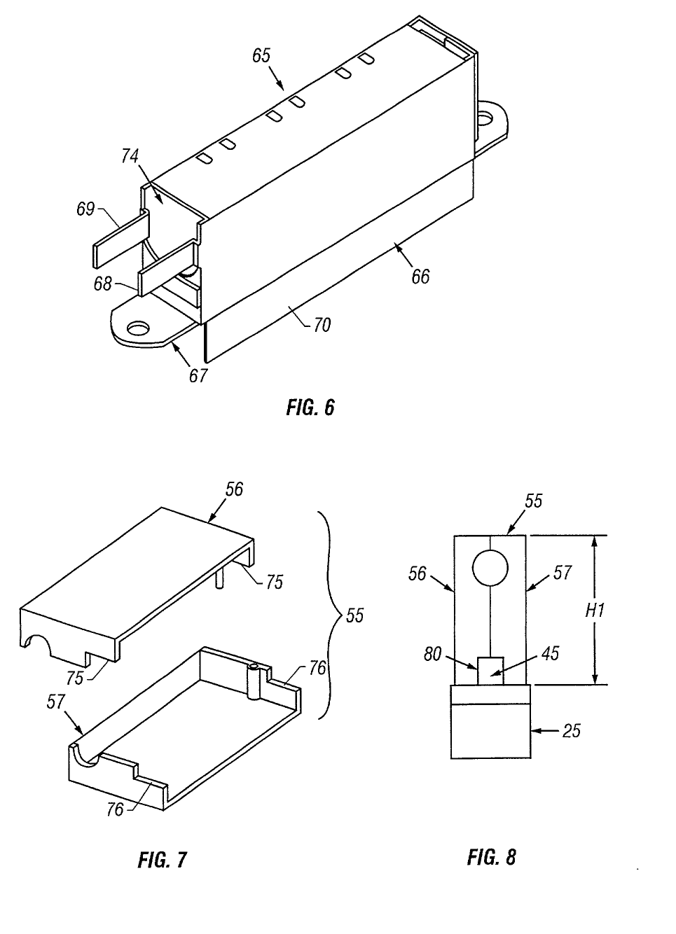

A multi-piece embodiment of the shielding body 65 is depicted in FIGS. 5 and 6. The shielding body 65 includes a first shielding member 66 and a second shielding member 67. The first and the second shielding members 66, 67 include respective cable grounding straps 68, 69, respective connector shielding portions 70, 71 and respective wire shielding portions 72, 73. The cable grounding straps 68, 69 are electrically connected to a shielding layer of the shielded cable 20, FIG. 1, for providing electrical continuity between the shielding body 65 and the shielding layer of the shielded cable 20.

The first and the second shielding members 66, 67 are capable of being assembled over the connector body 25 and the insulating insert 55. In this manner, the wire shielding portions 72, 73 form an insert-receiving region 74 for receiving the insulating insert 55 and the connector shielding portions 70, 71 cover at least a portion of the connector body 25. A cavity defined by the wire shielding portions 72, 73 of the shielding body 65 is an example of the insert-receiving region 74. It is contemplated that the shielding body 65 may be of a one-piece construction.

FIGS. 7 and 8 depicts an embodiment of the insulating insert 55 wherein the first and the second insulating members 56, 57 include respective shut-off surfaces 75, 76. The shut-off surfaces 75, 76 engage mating surfaces of the connector body 25, thus forming a shut-off interface 80, FIG. 8, between the insulating insert 55 and the connector body 25. In at least one embodiment, the shut-off surfaces 75, 76 engage mating surfaces defined by the wire attachment region 45 of the connector body 25.

The shut-off interface 80 is advantageous as it limits the flow of material into the wire-receiving region 60, FIG. 2, of the insulating insert during formation of the insulating cover 30. In some instances, such as when the insulating cover 30 is formed by an injection molding process, the material that formed the insulating cover 30 is under extremely high pressure. Accordingly, it is desirable to limit the flow of the material that formed the insulating cover 30 into the wire-receiving region 60 such that the potential for shorting of the contact members 35 and/or damaging the electrical connections at the wire attachment portion 40 is reduced.

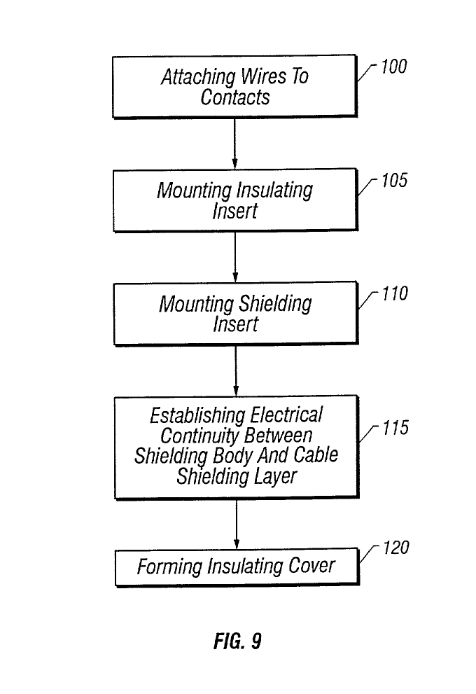

An embodiment of a method for forming the shielded cable assembly 10 is depicted in FIG. 9. An operation 100 is performed for attaching wires of a shielded cable to contacts of a connector assembly. An operation 105 is performed for mounting an insulating insert over the wires of the cable and over a wire attachment region of the connector body. An operation 110 is then performed for mounting a shielding body over the insulating insert and, in at least one embodiment, over at least a portion of the connector body. An operation 115 is performed for establishing electrical continuity between the shielding body and a shielding layer of the shielded cable. An operation 120 is then performed for forming the insulating cover.

A commercially available 50-position connector and commercially available shielding body, such as those available from Amp Incorporated, are examples of the connector body 25 and the shielding body 65, respectively. A CHAMP brand connector kit from Amp Incorporated includes a suitable commercially available connector and a suitable commercially available shielding body for fabrication a shielded connector assembly as disclosed herein. As discussed above, a suitable insulating insert may be fabricated using a process such as injection molding. A commercially available shielded cable, such as a 25-pair shielded cable from Prestolite Wire Corporation, is an example of the shielded cable 20.

The construction of the shielded connector assembly 15 disclosed herein is advantageous in applications where a shielded cable assembly including a low profile shielded connector assembly is desirable or required. A shielded cable assembly having a back-plane connector for Asymmetrical Digital Subscriber Line (ADSL) equipment is one example of an application where a shielded cable assembly including a low-profile shielded connector assembly is useful.

A low-profile shielding body is used in constructing a low-profile shielded connector assembly. A low-profile shielding body has at least one reduced dimension relative to a conventional profile shielding body. Reducing the height and/or overall size of the shielding body enables a low profile shielded connector assembly to be provided. However, reducing the height and/or overall size of the shielding body also reduces the clearance between the shielding body, contact members of the connector assembly, and wires connected to the contact members. In a conventional shielded connector assembly, the shielding body often deforms and/or moves during formation of the insulating cover, resulting in damage and/or shorting of the wires, contact members and electrical connections formed therebetween. The insulating insert disclosed herein advantageously reduces the potential for damage or shorting of the wires and contacts of the connector assembly.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A shielded cable assembly, comprising:
a connector body including a wire attachment region;
a contact member including a wire attachment portion, the contact member being mounted on the connector body with the wire attachment portion positioned adjacent to the wire attachment region of the connector body;
an insulating insert including a wire-receiving region, the insulating insert positioned adjacent to the connector body with at least a portion of the wire attachment region of the connector body extending into the wire-receiving region;
a cable including a wire, the wire extending into the wire-receiving region of the insulating insert and being electrically connected to the wire attachment portion of the contact member;
a shielding body including an insert-receiving region, at least a portion of the insulating insert positioned in the insert-receiving region; and
an insulating cover covering at least a portion of the shielding body.
